(19) United States
(12) Patent Application Publication
(10) Pub. No.: US 2024/0054589 A1
(43) Pub. Date: Feb. 15, 2024

(54) SYSTEMS AND METHODS FOR PREDICTIVE MODELING TO FACILITATE PEER-TO-PEER DISTRIBUTED GUARANTOR MARKETPLACES

(71) Applicant: Capital One Services, LLC, McLean, VA (US)

(72) Inventors: Xiaoguang ZHU, New York, NY (US); Jude Pierre ANASTA, Hudson, NY (US); Lin Ni Lisa CHENG, Fresh Meadows, NY (US)

(21) Appl. No.: 17/887,211

(22) Filed: Aug. 12, 2022

(51) Int. Cl. G06Q 50/18; G06Q 40/02

(52) U.S. Cl. CPC G06Q 50/188; G06Q 40/025

(57) ABSTRACT

The present disclosure provides systems and methods for predictive modeling to facilitate peer-to-peer distributed guarantor marketplaces. Example embodiments provide for generating a predictive model configured to calculate a coverage amount associated with a lease agreement. Example embodiments further provide for collecting lease information, gathering responses from guarantors, analyzing lease information and the guarantor responses, generating a predictive model, and calculating a coverage amount.

### FIELD OF DISCLOSURE

The present disclosure relates generally to systems and methods for generating a predictive model for guarantor payment.

### BACKGROUND

Applying for a lease can be difficult for a prospective lessee with bad credit. When a lessee (e.g., a recent graduate) has a particularly thin credit history, most lease applications require them to obtain one or more guarantors. These guarantors promise to insure the lessee for some predetermined amount in the event that the lessee fails to make a lease payment. Thus, the guarantor allows the lessee to obtain a lease that would otherwise be out of reach.

Although these guarantor agreements are helpful, a number of frustrations remain. If a lessee cannot find a single guarantor who can cover the amount set by the landlord, then the lessee cannot apply successfully for the lease. Furthermore, the lessee has little power to challenge the guarantee amount, even when doing so would be advantageous to both the lessor and lessee.

These and other deficiencies exist. Therefore, there is a need to provide systems and methods to establish guarantor marketplace that overcomes these deficiencies.

### SUMMARY OF DISCLOSURE

Embodiments of the present disclosure provide a distributed peer-to-peer multi-guarantor system. The system comprises a memory, a data storage unit configured to store at least lease information, application information, and guarantor information, and a processor. The processor is configured to calculate a coverage amount for one or more applicants in association with a lease application. The processor is further configured to receive lease information comprising at least lease duration, lease price, minimum guarantee price, and minimum guarantors and receive an application request from one or more applicants, the application request associated with the lease. The processor can transmit, upon receiving an application request, a lease application to the applicant, the lease application comprising at least one or more requests for guarantor contact information. Then, the processor can receive a completed lease application comprising guarantor contact information and transmit an approval request to one or more guarantors associated with the guarantor contact information. The processor can receive, in response to the approval request, one or more responses from the guarantors, the responses comprising at least an approval, a rejection, or an amendment to a guarantee agreement. Then, the processor can analyze, upon receiving one or more guarantee responses, the guarantee responses, the lease application, and the lease information. The process can generate, upon analyzing the guarantee responses, the guarantee responses, the lease application, and the lease information, a predictive model configured to determine a coverage amount associated with the one or more applicants. Then, the processor can update, by the processor, the predictive model with a set of new information associated with the applicant, landlord, and guarantors wherein the new information is stored in the data storage unit. The processor can calculate, by the predictive model, a new coverage amount associated with the one or more applicants, and transmit the new coverage amount to the one or more applicants.

Embodiments of the present disclosure also provide a method for facilitating a peer-to-peer multi-guarantor marketplace, the method comprising the steps of: receiving lease information comprising at least lease duration, lease price, minimum guarantee price, and minimum guarantors; receiving an application request from one or more applicants, the application request associated with the lease; transmitting, upon receiving an application request, a lease application to the applicant, the lease application comprising at least one or more requests for guarantor contact information; receiving a completed lease application comprising guarantor contact information; transmitting an approval request to one or more guarantors associated with the guarantor contact information; receiving one or more responses from the guarantors, the responses comprising at least an approval, a rejection, or an amendment to the guarantee agreement; analyzing, upon receiving one or more guarantee responses, the guarantee responses, the lease application, and the lease information; generating, upon analyzing the guarantee responses, the lease application, and the lease information, a predictive model configured to determine a coverage amount associated with the one or more applicants; updating, by a processor, the predictive model with a set of new information associated with the applicant, landlord, and guarantors wherein the new information is stored in the data storage unit; calculating, by the predictive model, a new coverage amount associated with the one or more applicants; and transmitting the new coverage amount to the one or more applicants.

Embodiments of the present disclosure also provide a computer readable non-transitory medium comprising computer executable instructions that, when executed on a processor, configure the processor to perform procedures comprising the steps of: receiving lease information comprising at least lease duration, lease price, minimum guarantee price, and minimum guarantors; receiving an application request from one or more applicants, the application request associated with the lease; transmitting, upon receiving an application request, a lease application to the applicant, the lease application comprising at least one or more requests for guarantor contact information; receiving a completed lease application comprising guarantor contact information; transmitting an approval request to one or more guarantors associated with the guarantor contact information; receiving one or more responses from the guarantors, the responses comprising at least an approval, a rejection, or an amendment to the guarantee agreement; analyzing, upon receiving one or more guarantee responses, the guarantee responses, the lease application, and the lease information; generating, upon analyzing the guarantee responses, the guarantee responses, the lease application, and the lease information, a predictive model configured to determine a coverage amount associated with the one or more applicants; updating, by the processor, the predictive model with a set of new information associated with the applicant, landlord, and guarantors wherein the new information is stored in the data storage unit; calculating, by the predictive model, a new coverage amount associated with the one or more applicants; and transmitting the new coverage amount to the one or more applicants.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 illustrates a system according to an exemplary embodiment.

FIG. 2 illustrates a flowchart according to an exemplary embodiment.

FIG. 3 illustrates a flowchart according to an exemplary embodiment.

FIG. 4 illustrates a flowchart according to an exemplary embodiment.

FIG. 5 illustrates a flowchart according to an exemplary embodiment.

FIG. 6 illustrates a block diagram according to an exemplary embodiment.

FIG. 7 illustrates a flowchart according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features, advantages, and characteristics of the embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or carry out combinations of special purpose hardware and computer instructions.

The embodiments provide systems and methods for generating a predictive model that can calculate a coverage amount for one or more guarantees. Example embodiments provide for collecting lease information which includes any guarantee requirements set by the lessor. The lessee receives the lease information and transmits it to multiple guarantors. Rather than rely on one or two guarantors, the lessee can rely on a number of guarantors each providing a sliver of the required guarantee amount. Once the guarantors receive the lease information, each guarantee can accept, reject, or amend the guarantee amount set in the lease application. The guarantees responses are sent back to the lessee. Next, a predetermined algorithm analyzes the lease information and the guarantees responses to generate a predictive model. The predictive model is configured to predict a coverage amount that satisfies both the lease requirements and the desires of the guarantors. The predictive model can be updated continuously with new data. Once the model has been updated, it can calculate a coverage amount and transmit the amount to the applicant and the guarantors for verification.

Systems and methods of the present disclosure provide numerous advantages. Rather than rely on a predetermined guarantor amount, a lessee is provided an adjustable coverage amount that is unique to every lease application. Furthermore, the lessee can choose multiple guarantors rather than one or two, and the lessee is not limited to guarantors the lessee can contact or know personally. Accordingly, the lessee can solicit coverage from a large pool of potential guarantors capable of covering various amounts, which increases the likelihood that the lessee can obtain a sufficient amount of coverage for the lessee's needs. This system can be referred to as a peer-to-peer guarantor system for its reliance on several guarantors. This can be done in an efficient and secure manner that safeguards the sensitive information of the lessee and the guarantors.

Systems and methods of the present disclosure can provide guarantors with numerous advantages as well. Potential guarantors can be easily connected with applicants and securely provide coverage. Guarantors are afforded significant freedom to adjust the guarantor amount to fit their needs, which increases guarantor participation and confidence.

Systems and methods of the present disclosure can further provide financial institutions or other loan issuing entities with significant advantages. By efficiently and securely connecting applicants with one or more guarantors, loans can be secured by one or multiple guarantors. By reducing the barriers and friction for establishing coverage amounts between applicants and one or more multiple guarantors, overall loan activity can be increased.

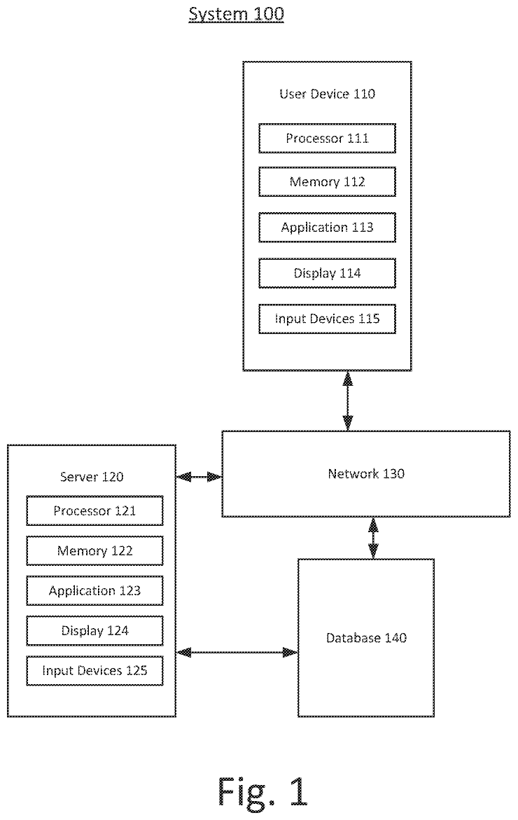

FIG. 1 illustrates a system according to an exemplary embodiment. The system 100 may comprise a user device 110, a server 120, a network 130, and a database 140. Although FIG. 1 illustrates single instances of components of system 100, system 100 may include any number of components.

System 100 may include a user device 110. The user device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, an automatic teller machine (ATM), or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 110 may include a processor 111, a memory 112, and an application 113. The processor 111 may be a processor, a microprocessor, or other processor, and the user device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the user device 110 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's private data and financial account information.

The application 113 may comprise one or more software applications, such as a mobile application and a web browser, comprising instructions for execution on the user device 110. In some examples, the user device 110 may execute one or more applications, such as software applications, that enable, for example, network communications with one or more components of the system 100, transmit and/or receive data, and perform the functions described herein. Upon execution by the processor 111, the application 113 may provide the functions described in this specification, specifically to execute and perform the steps and functions in the process flows described below. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the user device 110 that is available and supported by the user device 110, such as a touch-screen, keyboard, mouse, cursor-control device, touch-screen, microphone, digital camera, video recorder or camcorder. These devices may be used to enter information and interact with the software and other devices described herein.

System 100 may include a server 120. The server 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 120 may include a processor 121, a memory 122, and an application 123. The processor 121 may be a processor, a microprocessor, or other processor, and the server 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the server 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications comprising instructions for execution on the server 120. In some examples, the server 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described below. For example, the application 123 may be executed to perform receiving web form data from the user device 110, retaining a web session with the user device 110, and masking private data received from the user device 110. Such processes may be implemented in software, such as software modules, for execution by computers or other machines. The application 123 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the server 120 that is available and supported by the server 120, such as a touch-screen, keyboard, mouse, cursor-control device, touch-screen, microphone, digital camera, video recorder or camcorder. These devices may be used to enter information and interact with the software and other devices described herein.

System 100 may include one or more networks 130. In some examples, the network 130 may be one or more of a wireless network, a wired network or any combination of wireless network and wired network, and may be configured to connect the user device 110, the server 120, and the database 140. For example, the network 130 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 130 may include, without limitation, telephone lines, fiber optics, IEEE Ethernet 902.3, a wide area network, a wireless personal area network, a LAN, or a global network such as the Internet. In addition, the network 130 may support an Internet network, a wireless communication network, a cellular network, or the like, or any combination thereof. The network 130 may further include one network, or any number of the exemplary types of networks mentioned above, operating as a stand-alone network or in cooperation with each other. The network 130 may utilize one or more protocols of one or more network elements to which they are communicatively coupled. The network 130 may translate to or from other protocols to one or more protocols of network devices. Although the network 130 is depicted as a single network, it should be appreciated that according to one or more examples, the network 130 may comprise a plurality of interconnected networks, such as, for example, the Internet, a service provider's network, a cable television network, corporate networks, such as credit card association networks, and home networks. The network 130 may further comprise, or be configured to create, one or more front channels, which may be publicly accessible and through which communications may be observable, and one or more secured back channels, which may not be publicly accessible and through which communications may not be observable.

System 100 may include a database 140. The database 140 may be one or more databases configured to store data, including without limitation, private data of users, financial accounts of users, identities of users, transactions of users, and certified and uncertified documents. The database 140 may comprise a relational database, a non-relational database, or other database implementations, and any combination thereof, including a plurality of relational databases and non-relational databases. In some examples, the database 140 may comprise a desktop database, a mobile database, or an in-memory database. Further, the database 140 may be hosted internally by the server 120 or may be hosted externally of the server 120, such as by a server, by a cloud-based platform, or in any storage device that is in data communication with the server 120.

In some examples, exemplary procedures in accordance with the present disclosure described herein can be performed by a processing arrangement and/or a computing arrangement (e.g., computer hardware arrangement). Such processing and/or computing arrangement can be, for example entirely or a part of, or include, but not limited to, a computer/processor that can include, for example one or more microprocessors, and use instructions stored on a non-transitory computer-readable medium (e.g., RAM, ROM, hard drive, or other storage device). For example, a computer-readable medium can be part of the memory of the user device 110, server 120, database 140, or other computer hardware arrangement.

In some examples, a computer-readable medium (e.g., as described herein, a storage device such as a hard disk, floppy disk, memory stick, CD-ROM, RAM, ROM, etc., or a collection thereof) can be provided (e.g., in communication with the processing arrangement). The computer-readable medium can contain executable instructions thereon. In addition or alternatively, a storage arrangement can be provided separately from the computer-readable medium, which can provide the instructions to the processing arrangement so as to configure the processing arrangement to execute certain exemplary procedures, processes, and methods, as described herein above, for example.

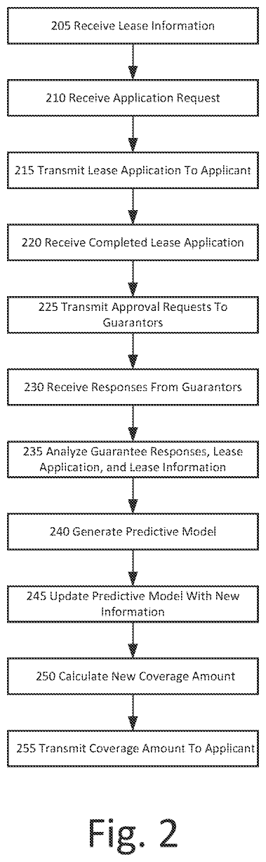

FIG. 2 illustrates a method according to an exemplary embodiment. The method generally relates to receiving lease information, transmitting approval requests to multiple guarantors, analyzing the guarantors' responses, and generating a new coverage amount.

In action 205, lease information is received by the applicant. The lease information can include without limitation monthly or yearly costs, duration, location, deposit, insurance, utilities price, and guarantor requirements. Guarantor requirements can further include without limitation a minimum number of guarantors, total guarantee amount, and duration. The lease information can be sent over a network by a processor associated with a server or user device. The lease information can be stored in a database or data storage unit.

In action 210, an application request is received. The application request can be associated with a lease term offered by a landlord. The lease term can be associated with a lease agreement including but not limited to a housing lease, storage lease, business or corporate lease, and automobile lease.

In action 215, a lease application is transmitted to the applicant. This action can be performed by a processor associated with the server or user device. The lease application can include without limitation monthly or yearly costs, duration, location, deposit, insurance, utilities price, and guarantor requirements. The applicant, upon receiving the lease application, can complete the lease application. The lease application may be completed by filling out a form on a third party application made available by the server or user device.

In action 220, the server can receive the completed lease application including at least guarantor information. The guarantor information can include without limitation guarantor names, email, phone number, address, and guarantee amount. Other personal information may be included to verify the guarantor's identity and financial information. The guarantor information can be stored in the data storage unit or database. This action can be performed by a processor associated with the server.

In action 225, the server can transmit approval requests to the guarantors. The approval requests can be associated with the guarantor information supplied by the applicants. The requests can be sent to a third party application associated with lease agreements and guarantor agreements. The request can be sent over a network.

In action 230, the server can receive one or more responses from the guarantors. The responses can include without limitation an approval, a rejection, or an amendment to the guarantor agreement. An approval would constitute an agreement to supply the guarantee amount specified by the lease-applicant. A rejection would constitute a rejection of the terms supplied by the lease-applicant as well as a general rejection of becoming a guarantor for the applicant. An amendment would constitute a rejection of the terms but also an offer to supply a different guarantee amount. In turn, this amended amount can be transmitted back to the user over a network. The user can respond to the amended with an approval or rejection.

In action 235, the server can analyze the guarantee responses, the lease application, and the lease information. The analysis can be performed by a processor or algorithm that has been trained to generate predictive models related to guarantee agreements. In addition, the algorithm can consider other factors including but not limited to local pricing factors, historical pricing data, the applicant's future earning potential, the applicant's employment history, and the applicant's credit history.

In action 240, the algorithm can generate a predictive model configured to calculate a coverage amount. Additionally, the predictive model can be configured to predict the applicant's future earning potential, which in turn can be factored into the coverage amount. In action 245, the server can update the predictive model with additional information. This additional information can include new financial information associated with the application, new guarantor requirements, new local pricing data, and other lease factors. This additional information can be supplied by the applicant.

In action 250, the predictive model can calculate a new coverage amount. The coverage amount can be split up between multiple guarantors. In action 255, the coverage amount is transmitted to the applicant. This action can be performed by a processor over a network.

It is understood that the coverage amount may be changed and updated according to circumstances arising during the lifetime of the lease. As a nonlimiting example, the applicant may start a new career in which he or she makes more money. This change in income can be given to the algorithm at which point that coverage amount can be adjusted. As another nonlimiting example, guarantors may agree to guarantee the applicant's payment up to a predetermined time period. For example, a guarantor may have to guarantee the applicant for only the first six months at which point the guarantor is released from the lease application. As another example, the guarantor can be released from the agreement after a predetermined number of rent payments have been successfully paid by the applicant. As another non-limiting example, the guarantor amounts can be changed manually by the applicant or guarantor.

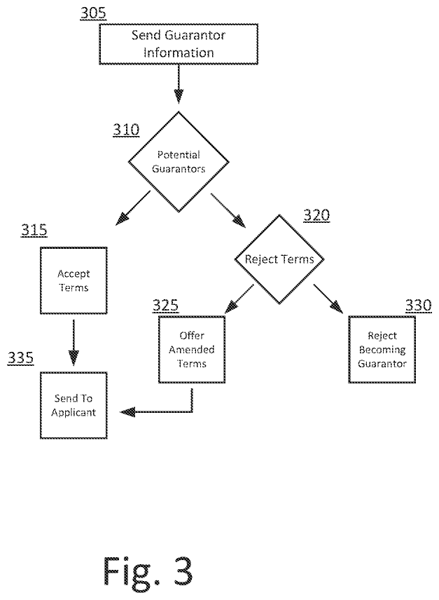

FIG. 3 is a block diagram illustrating a method according to an exemplary embodiment.

In actions 305 and 310, guarantor information is sent to the guarantors. Guarantor information can include information relating to a lease application, including but not limited to pricing information, lease location, lease duration, and individual guarantor requests. Each guarantor may be requested to guarantee a different rent amount according to the request of the applicant. The guarantor information can be gathered from a lease application or applicant. This action can be performed by a processor associated with a user device or server. The guarantor information can be sent over a network. Upon sending the guarantor information to one or more potential guarantors, the potential guarantors can either accept the guarantor terms 315 or reject the guarantor terms 320. By accepting the guarantor terms, the guarantee agrees to guarantee the applicant's lease for the amount originally set by the applicant. The guarantee may supply acceptance with a verification credential such as financial information, employment information, or asset information. If the guarantor accepts the terms, the terms can be sent to the applicant for further review 335. If the guarantor rejects the terms originally set by the applicant, the guarantor can either reject becoming a guarantor 330 or offer amended guarantor terms 325 to the applicant. As a nonlimiting example, the guarantor may offer a different guarantee amount, a different guarantee time period, or some other stipulation. If the guarantor offers amended terms to the guarantee, the amended terms can be sent to the applicant 335.

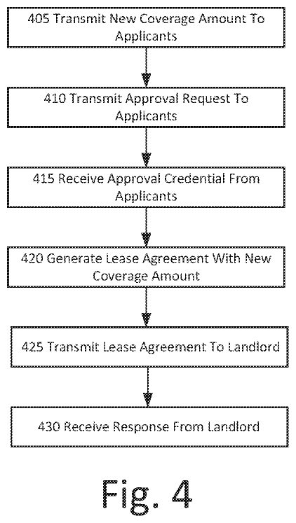

FIG. 4 is a flowchart illustrating a process according to an exemplary process.

Once the new coverage amount has been generated by the algorithm, the new coverage amount is transmitted to the applicant in action 405. This action may be performed by a processor over a network. In action 410, the server can transmit an approval request to the one or more applicants. The approval request can be transmitted by the server to one or more user devices associated with the applicants. In response to the approval requests, in action 415 the server can receive one or more approval credentials from the applicants. The approval credential can include without limitation a password, card information, or security question. In action 420, the server can generate a lease agreement with the new coverage amount. The lease agreement can include without limitation a leasing price, guarantee amount, guarantor identifying information, lease duration, and other security provisions. In action 425, the server can transmit the lease agreement to the landlord. This action can be performed by a processor associated with a server. The lease agreement may be sent over a network. In action 430, the serve can receive a response from the landlord. The response can include an approval, rejection, or proposed amendment to the lease agreement.

It is understood that the server or processor can be provisioned to perform additional tasks related to completing and submitting the lease agreement. As a nonlimiting example, the processor can calculate a deposit amount associated with the lease agreement. The processor can consider without limitation local pricing factors, historical pricing data, the applicant's future earning potential, the applicant's employment history, and the applicant's credit history. If the landlord approves of the deposit amount, the processor can allocate the deposit amount into an escrow or holding account associated with the landlord. This action can be performed by a predetermined algorithm.

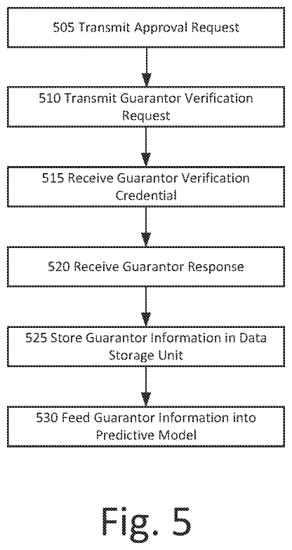

FIG. 5 is a flowchart illustrating a method according to an exemplary embodiment.

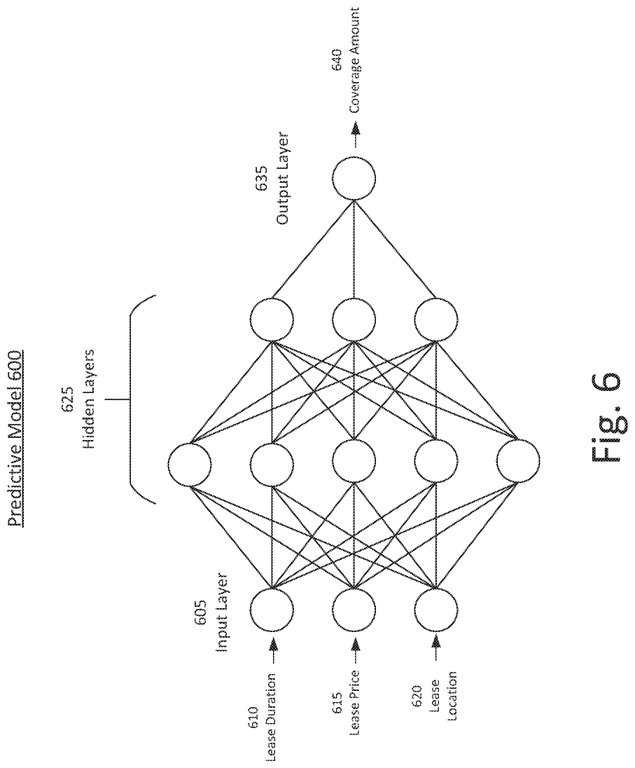

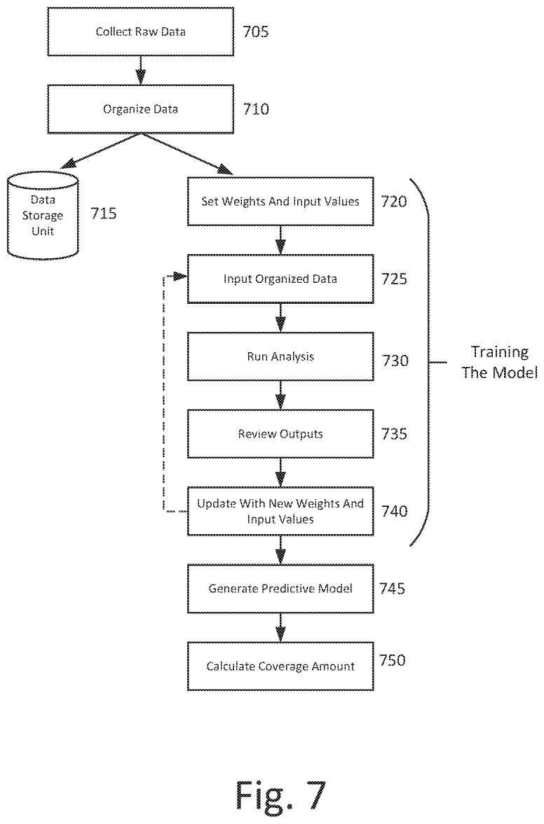

In action 505, the server can transmit an approval request to one or more guarantors. Generally, the approval request asks the guarantor to accept, reject, or amend the guarantee terms set by the applicant. The one or more guarantors can be selected from the information provided by the lease-applicant. The lease-applicant may provide the server with guarantor identifying information including but not limited to name, email, phone number, and address. The approval request can include without limitation lease information and the applicant's guarantor proposals. The guarantor proposals can include the lease-applicant's proposed guarantor parameters associated with the lease agreement. Each parameters can differ for each guarantor. For example, the applicant may ask a first guarantor to guarantee $100, and they may ask a second guarantor to guarantee only $50. Other parameters can include time duration. As a nonlimiting example, the applicant may ask the guarantor guarantee a small amount of money for only the first six months of the lease duration. Additionally, the applicant may ask for a parameter associated with certain payment goals. As a nonlimiting example, the applicant may ask a guarantor to guarantee a certain amount of money until the applicant makes eight successful lease payments, or until the applicant's income reaches higher than $75,000. In addition, the server can also transmit a verification request in action 510 to one or more guarantors. This action can be performed by a processor associated with the server or user device. In response, the server can receive one or more verification credentials in action 515. The verification credentials can verify the guarantor's identity verification, income verification, and asset verification. The verification credentials can include without limitation card information, financial information associated with a banking institution or some other third party financial application, asset information, employment history, credit history, and any past history of being a guarantor. Additionally, the guarantor verification credentials can include other payment history—such as a mortgage—and social media information. The verification credentials may be provided by a third party financial app such as Paypal, Mint, or Plaid. In action 520, the server can receive the guarantor response to the approval request. The guarantor response can comprise at least one of an approval, a rejection, or an amendment. The amendment can include without limitation a proposal to guarantee a higher or lower amount than what was specified by the applicant in the approval request. The process for requesting and receiving guarantor responses is discussed with further reference to FIG. 3. Upon receiving the guarantor responses, in action 525 a processor associated with the server can store the guarantor information into a database or data storage unit. The data storage unit is discussed with further reference to FIG. 1. The guarantor information may be separate into discernable categories before being stored in the database. In action 530, the processor can feed the guarantor information into the predictive model. Along with other information gathered from the applicant and the lease, the guarantor information can act as one or more inputs in a predictive model or neural network discussed with further reference to FIGS. 6 and 7.

Generally, the guarantor responses may be created by the guarantors through a website, web application, or mobile application available through the guarantor verification request. The response can be generated and transmitted by a processor associated with a user device and sent over a wired or wireless network. The guarantor responses can be sent to a user device or server associated with the applicant.

FIG. 6 is a diagram illustrating a neural network as an exemplary embodiment for the predictive model.

A neural network is a series of algorithms that can, under predetermined training restrictions, recognize relationships between one or more variables. A neuron in a neural network is a mathematical function that collects and classifies information according to a specific form set by a user. Generally, a neural network can be divided into three main components: an input layer, a processing or hidden layer, and an output layer. The input layer comprises data sets chosen to be inserted into the neural network for analysis. The hidden layers include one or more neurons that can classify the inputs according to parameters set by the user. The hidden layers can comprise multiple successive layers, the first layer positioned immediately after the input layer and the last layer positioned immediately before the output layer. The hidden layer immediately after the input layer may be connected to the input layer via a predetermined weight or emphasis. These weights can be assigned according to the modeler's agenda. Alternatively, the model itself can determine the optimal weights between layers such that a predetermined outcome, margin of error, or minimum data point is achieved.

The predictive model can comprise a neural network 600. The neural network may be integrated into the server, the user device, or some other computer device suitable for neural network analysis. The neural network can include generally an input layer 605, one or more hidden layers 625, and an output layer 635. Although only a certain number of nodes are depicted in FIG. 6, it is understood that the neural network according to the disclosed embodiments may include less or more nodes in each layer. Additionally, the hidden layers can include more or less layers than what is depicted in FIG. 6. It is also understood that the connections between each layer may be assigned a predetermined weight according to user's manual change or according to some weight value generated by the neural network itself. The input layer may include sets of data gathered from outside sources. The neural network can include lease information including lease duration 610, lease price 615, and lease location 620. Other inputs not depicted in FIG. 6 may also comprise inputs such as historical information related to the lease, guarantor-guarantee minimum requirements, and other information associated with the lease applicant such as credit history, current income, future expected income, assets, past lease history, and other information. The neurons associated with the hidden layers can be trained or provisioned to classify the inputs according to parameters set by the user. As a nonlimiting example, the user can train the hidden layer to associate a higher lease price with a greater guarantee amount. As another example, the hidden layer can be trained to associate a certain lease location—for example, in New York City—with a guarantee amount that matches guarantee amounts found elsewhere in the location. Upon analyzing the inputs via the one or more hidden layers, the neural network can create an output or coverage amount 640. It is understood that the neural network can be provisioned to create other outputs such as minimum guarantors, lease prices, and other outputs associated with leases. It is understood that one or more neural networks or some combination of neural networks can be trained according to individual lease applicants, applicants within a certain geographic limit, income limit, age limit, or applicants associated with a specific leasing office or leasing property.

The exemplary system, method and computer-readable medium can then apply the generated models to calculate a most efficient coverage amount associated with a lease application. For example, the exemplary model can include information such as historical information related to the lease, guarantor-guarantee minimum requirements, and other information associated with the lease applicant such as credit history, current income, future expected income, assets, past lease history, and other information.

The predictive models described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The exemplary system, method and computer-readable medium can utilize various neural networks, such as convolutional neural networks (CNNs) or recurrent neural networks (RNNs), to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (LSTMs) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data en route from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the predictive models described herein may be training prior to use and the training may continue with updated data sets that reflect additional information.

FIG. 7 is a flowchart illustrating the generation of a predictive model and the calculating of a coverage amount.

The process 700 describes the training process for an exemplary predictive model or neural network suitable for predicting and calculating a coverage amount associated with a lease-applicant. The process can begin with action 705 when raw data is collected. The raw data can be associated with the lease, the lease applicant, and the guarantees. The information can further include lease price, lease duration, lease location, lease history, applicant income, applicant credit history, applicant assets, guarantee assets, guarantee credit history, information associated with the applicant's checking and saving accounts, and related information. The collection of raw data can be performed by a processor or application associated with the user device or server. The raw data can be transmitted over a wired or wireless network. The data may have been previously gathered and stored in a database or data storage unit in which case the processor or application can retrieve the data from the data storage unit. At action 710, the processor or application can organize the raw data into discernable categories including but not limited to applicant data, landlord data, guarantee data, and lease-property data. The categories can be predetermined by the user or created by the predictive model. At action 715, the organized or raw data can be transmitted to the data storage unit. The data storage unit can be associated with the user device or server. The raw or organized data can be transmitted over a wired network, wireless network, or one or more express buses. Upon organizing the data into one or categories, the processor or application can proceed with training the predictive model in actions 720 through 740. Generally, the training portion can have any number of iterations. The predictive model can comprise one or more neural network described with further reference to FIG. 6.

The training portion can begin with action 720 when the weights and input values are set by the user or by the model itself. Furthermore, the weights can be the predetermined connections between the inputs and the hidden layers described with further reference to FIG. 6. The input values are the values that are fed into the neural network. The input values may be discerned by the different categories created in action 710, although other distinct input values may be discerned. The inputs can include without limitation historical information related to the lease, guarantor-guarantee minimum requirements, and other information associated with the lease applicant such as credit history, current income, future expected income, assets, past lease history, and other information. In action 725, the data in inputted in the neural network, and in action 730 the neural network analyzes the data according to the weights and other parameters set by the user. As a nonlimiting, example, the user may create the stipulation that no guarantee can be less than one percent of the total lease-duration price. In action 735, the outputs are reviewed. The outputs can include one or more coverage amounts associated with the lease-applicant and the guarantors, or any relevant output determined by the user. In action 740, the predictive model may be updated with new data and parameters. The new data can be collected by the processor in a similar fashion to actions 705 and 710. Though it is not necessary in this exemplary embodiment to retrain the predictive model, the predictive model can be re-trained any number times such that actions 725 through 740 are repeated until a satisfactory output is achieved or some other parameter has been met. As a nonlimiting example, the user may update the inputs with new pricing data. As another nonlimiting example, the user can adjust the weighted relationship between the input layer and the one or more hidden layers of a neural network discussed with further reference to FIG. 6. If a satisfactory output has been recorded, then in action 745 one or more predictive models can be generated. It is understood that the predictive model, once generated, can undergo further training similar to actions 720 to 745. Having generated the predictive model, in action 750 the model can calculate a coverage amount given the unique input values collected from a particular lease-applicant and their associated peers. It is understood that the predictive model may calculate other values including without limitation suggested lease prices, suggested lease duration, future lease prices, future property value associated with the lease, and other values.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

As used herein, user information, personal information, and sensitive information can include any information relating to the user, such as a private information and non-private information. Private information can include any sensitive data, including financial data (e.g., account information, account balances, account activity), personal information/personally-identifiable information (e.g., social security number, home or work address, birth date, telephone number, email address, passport number, driver's license number), access information (e.g., passwords, security codes, authorization codes, biometric data), and any other information that user may desire to avoid revealing to unauthorized persons. Non-private information can include any data that is publicly known or otherwise not intended to be kept private.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer-readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified in herein. These computer-readable program instructions may also be stored in a computer-readable storage medium that can direct a computer, a programmable data processing apparatus, and/or other devices to function in a manner, such that the computer-readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions specified herein.

We claim:

1. A distributed peer-to-peer multi-guarantor system, comprising:
a memory;
a data storage unit configured to store at least lease information, application information, and guarantor information; and
a processor configured to calculate a coverage amount for one or more applicants in association with a lease application, the processor further configured to:
receive lease information comprising at least lease duration, lease price, minimum guarantee price, and minimum guarantors;
receive an application request from one or more applicants, the application request associated with the lease;
transmit, upon receiving an application request, a lease application to the applicant, the lease application comprising at least one or more requests for guarantor contact information;
receive a completed lease application comprising guarantor contact information;
transmit an approval request to one or more guarantors associated with the guarantor contact information;
receive, in response to the approval request, one or more responses from the guarantors, the responses comprising at least an approval, a rejection, or an amendment to a guarantee agreement;
analyze, upon receiving one or more guarantee responses, the guarantee responses, the lease application, and the lease information;
generate, upon analyzing the guarantee responses, the guarantee responses, the lease application, and the lease information, a predictive model configured to determine a coverage amount associated with the one or more applicants;
update, by the processor, the predictive model with a set of new information associated with the applicant, landlord, and guarantors wherein the new information is stored in the data storage unit;
calculate, by the predictive model, a new coverage amount associated with the one or more applicants; and
transmit the new coverage amount to the one or more applicants.

2. The system of claim 1, wherein upon transmitting the new coverage amount to the one or more applicants, the processor is further configured to:
transmit an approval request to the applicants;
receive an approval credential from the applicants;
generate, upon receiving an approval from the applicants, a lease agreement comprising the new coverage amount;
transmit the lease agreement to a landlord associated with the lease; and
receive, from the landlord, a response associated with the lease agreement, the response comprising either an acceptance or rejection.

3. The system of claim 1, wherein prior to analyzing the guarantor responses, the processor is further configured to:
transmit a guarantor verification request, the guarantor verification request comprising at least an identity verification request, an income verification request, and an asset verification request; and
receive, from one or more guarantors, a guarantor verification credential comprising at least an identity credential, an income credential, and an asset credential.

4. The system of claim 1, wherein the processor is further configured to:
remove one or more guarantors from the lease agreement upon one or more predetermined events occurring.

5. The system of claim 4, wherein the one more predetermined events comprise at least a predetermined number of rent payments or a predetermined number of months passing.

6. The system of claim 1, wherein the processor further configured to retrieve credit history and employment history associated with an applicant.

7. The system of claim 1, wherein the predictive model is further configured to:
calculate, upon determining a new coverage amount, a deposit amount associated with the lease; and
allocate the deposit amount into a holding account associated with the landlord.

8. The system of claim 1, wherein the processor is further configured to retrieve payment history information associated with the applicant.

9. A method for facilitating a peer-to-peer multi-guarantor marketplace, the method comprising the steps of:
receiving lease information comprising at least lease duration, lease price, minimum guarantee price, and minimum guarantors;
receiving an application request from one or more applicants, the application request associated with the lease;
transmitting, upon receiving an application request, a lease application to the applicant, the lease application comprising at least one or more requests for guarantor contact information;
receiving a completed lease application comprising guarantor contact information;
transmitting an approval request to one or more guarantors associated with the guarantor contact information;
receiving one or more responses from the guarantors, the responses comprising at least an approval, a rejection, or an amendment to a guarantee agreement;
analyzing, upon receiving one or more guarantee responses, the guarantee responses, the lease application, and the lease information;
generating, upon analyzing the guarantee responses, the lease application, and the lease information, a predictive model configured to determine a coverage amount associated with the one or more applicants;
updating, by a processor, the predictive model with a set of new information associated with the applicant, landlord, and guarantors wherein the new information is stored in a data storage unit;
calculating, by the predictive model, a new coverage amount associated with the one or more applicants; and
transmitting the new coverage amount to the one or more applicants.

10. The method of claim 9, wherein upon transmitting the new coverage amount to the one or more applicants, the method further comprises the steps of:
transmitting an approval request to the applicants;
receiving an approval credential from the applicants;
generating, upon receiving an approval from the applicants, a lease agreement comprising the new coverage amount;
transmitting the lease agreement to a landlord associated with the lease; and
receiving, from the landlord, a response associated with the lease agreement, the response comprising either an acceptance or rejection.

11. The method of claim 9, wherein prior to analyzing the guarantor responses, the method further comprises the steps of:
transmitting a guarantor verification request, the guarantor verification request comprising at least an identity verification request, an income verification request, and an asset verification request; and
receiving, from one or more guarantors, a guarantor verification credential comprising at least an identity credential, an income credential, and an asset credential.

12. The method of claim 9, wherein lease information includes historical pricing data associated with the lease.

13. The method of claim 10, wherein new coverage amount is changed manually by one or more applicants prior to transmitting the lease agreement to the landlord.

14. The method of claim 9, wherein the method further comprises the steps of retrieving information from a checking and savings account associated with one or more banks associated with the applicant.

15. The method of claim 9, wherein the method further comprises retrieving information from third party applications associated with the applicant's financial history.

16. The method of claim 9, wherein the method further comprises predicting, by the predictive model, the applicant's future income and assets.

17. A computer readable non-transitory medium comprising computer executable instructions that, when executed on a processor, configure the processor to perform procedures comprising the steps of:
receiving lease information comprising at least lease duration, lease price, minimum guarantee price, and minimum guarantors;
receiving an application request from one or more applicants, the application request associated with the lease;
transmitting, upon receiving an application request, a lease application to the applicant, the lease application comprising at least one or more requests for guarantor contact information;
receiving a completed lease application comprising guarantor contact information;
transmitting an approval request to one or more guarantors associated with the guarantor contact information;
receiving one or more responses from the guarantors, the responses comprising at least an approval, a rejection, or an amendment to a guarantee agreement;
analyzing, upon receiving one or more guarantee responses, the guarantee responses, the lease application, and the lease information;
generating, upon analyzing the guarantee responses, the guarantee responses, the lease application, and the lease information, a predictive model configured to determine a coverage amount associated with the one or more applicants;
updating, by the processor, the predictive model with a set of new information associated with the applicant, landlord, and guarantors wherein the new information is stored in a data storage unit;
calculating, by the predictive model, a new coverage amount associated with the one or more applicants; and
transmitting the new coverage amount to the one or more applicants.

18. The computer-readable storage medium of claim 17, wherein the processor is further configured to perform procedures comprising the steps of:
transmitting an approval request to the applicants;
receiving an approval credential from the applicants;
generating, upon receiving an approval from the applicants, a lease agreement comprising the new coverage amount;
transmitting the lease agreement to a landlord associated with the lease; and
receiving, from the landlord, a response associated with the lease agreement, the response comprising either an acceptance or rejection.

19. The computer-readable storage medium of claim 17, wherein the processor is further configured to perform procedures comprising the steps of:
transmitting a guarantor verification request, the guarantor verification request comprising at least an identity verification request, an income verification request, and an asset verification request; and
receiving, from one or more guarantors, a guarantor verification credential comprising at least an identity credential, an income credential, and an asset credential.

20. The computer-readable storage medium of claim 19, wherein the guarantor verification credential further comprises payment history information and a social media profile.
